(19) United States
(12) Patent Application Publication
(10) Pub. No.: US 2025/0257534 A1
(43) Pub. Date: Aug. 14, 2025

(54) PET WASTE PICK UP POWER TOOL SYSTEM AND METHOD OF USE

(71) Applicant: Marc R Price, Prairie Village, KS (US)

(72) Inventor: Marc R Price, Prairie Village, KS (US)

(21) Appl. No.: 19/193,132

(22) Filed: Apr. 29, 2025

Related U.S. Application Data
(63) Continuation-in-part of application No. 18/137,644, filed on Apr. 21, 2023.
Application No. 18/137,644 is a continuation-in-part of application No. 16/906,868, filed on Jun. 19, 2020, now abandoned.
(60) Provisional application No. 62/921,449, filed on Jun. 19, 2019.

(51) Int. Cl. E01H 1/12; A47L 5/24; A47L 9/14

(52) U.S. Cl. CPC E01H 1/1206; A47L 5/24; A47L 9/1427

(57) ABSTRACT

A waste collection device including a compartment for receiving pet waste or other reusable collected objects. The device is attached to the end of a leaf blower vacuum, hand vacuum, or other device which provides suction. Accessories may be included which allow universal mounting to most or all types of vacuums and leaf blower vacuums. A removable filter bag may be included for cleaner removal of waste. The attachment can be the power tool where the cup or bag fits inside or attached to. The waste collection device can include a light.

### CROSS-REFERENCE TO RELATED APPLICATION

This application is a continuation-in-part and claims priority in U.S. patent application Ser. No. 18/137,644, filed Apr. 21, 2023, which is a continuation-in-part of and claims priority in U.S. patent application Ser. No. 16/906,868, filed Jun. 19, 2020 which claims priority in U.S. Provisional Patent Application No. 62/921,449 filed Jun. 19, 2019, and this application also claims priority in U.S. Provisional Patent Application No. 63/791,400 filed Apr. 30, 2024, all of which are incorporated herein by reference.

### BACKGROUND OF THE INVENTION

### 1. Field of the Invention

The present invention relates generally to an attachment and method for use thereof, and more specifically to a collection attachment which can be used with a leaf blower vacuum, hand held vacuum, or any device which provides suction. The device can be used to collect pet waste or could be used to pick up small objects, such as pills or other reusable elements.

### 2. Description of the Related Art

Commonly, local laws, ordinances, or homeowners' associations require pet owners to remove and dispose of pet waste immediately or very soon after it is deposited. Even if a pet owner is not required by rule or regulation to remove pet waste, many pet owners prefer to remove it to maintain the cleanliness of their lawns, neighborhoods, and environment. Typically, pet waste is removed by using a bag, either with or without a shovel or scoop, to collect the waste. This activity requires the user to bend or stoop. This method is unpleasant and can result in the inadvertent transfer of waste to a user, which can be hazardous to the person's health.

Typically, devices for waste collection include shovels, scoops, bags, and other devices that require the user to have relatively good mobility and strength. Motorized devices are often heavy and/or bulky, difficult to transfer long distances, and require the user to have relatively good strength and flexibility. Even if the motorized devices are lighter in weight, each has its limitations. Commonly, motorized devices can be soiled during use and must be cleaned to eliminate undesirable odors and potential health risks from waste residue.

U.S. Pat. No. 10,022,026, which has the same inventor as the present application and is incorporated herein by reference, teaches a device aimed at picking up pet waste or reusable objects using suction. However, since most households already own a power tool which can provide vacuum suction such as a leaf blower vacuum or handheld vacuum, it may not be feasible to purchase an additional specialized device for the purposes of picking up waste. What is needed is a device which can provide the functionality of picking up waste such as pet waste while being usable with most or all existing vacuum-type devices.

Additional features of the present invention allow the device to pick up small objects, such as pills, coins, or other small objects. Individuals that have arthritis, back pain, degenerative disc disease, coordination problems, poor eyesight, or other nerve or muscular problems that limit mobility can find cleaning up pet waste, debris, or other small objects by using such devices to be a particularly difficult task. The present invention can replace typical grabber devices for picking up small objects.

Heretofore there has not been available a system or method for a waste collection device or small reusable object pickup with the advantages and features of the present invention.

### BRIEF SUMMARY OF THE INVENTION

The present invention generally provides a waste collection device including a compartment for receiving pet waste or other waste. The device is attached to the end of a leaf blower vacuum, hand type vacuum such as stick and car vacuums, or other device which provides suction. Accessories may be included which allow universal mounting to most or all types of vacuums and leaf blower vacuums.

The leaf blower vacuum or vacuum device includes a motor and fan, along with other components, which provide air suction for drawing waste into the disposable container. The leaf blower vacuum or other vacuum device may run on any common power type, from battery to electricity to gasoline to solar energy. The vacuum or leaf blower vacuum may have a cord or be cordless and may have one-way suction or two-way blow/suction functionality.

In an embodiment affixed to a leaf blower vacuum, the leaf blower vacuum may have a telescopic tube or interlocking tubes which allow for extension of the distal end of the leaf blower. The compartment of the present invention could affix itself to any length of tube or simply to the end of the leaf blower vacuum itself for optimal universality.

The present invention could be used in conjunction with stick and/or wet dry vacuums.

By using this compartment with a vacuum device, including a leaf blower vacuum, the user's hands remain clean as the waste is deposited into the compartment. A bag or filter may be included within the compartment to capture the waste, adding an additional layer of security between the user and the waste. Clips or other means of retaining the bag or filter in position may be employed within or on the exterior of the compartment. After use, the bag is sealed, tied, or other means to throw away. The back wall of the filter guard prevents the bag or collected waste or other items from being drawn into the power tool.

### BRIEF DESCRIPTION OF THE DRAWINGS

The drawings constitute a part of this specification and include exemplary embodiments of the present invention illustrating various objects and features thereof.

FIG. 1 is a three-dimensional diagram of a preferred embodiment of the present invention showing hidden features and elements in dashed lines.

FIG. 1A is a detailed three-dimensional diagram of a filter bag element thereof.

FIG. 2 is a three-dimensional diagram thereof showing the preferred embodiment of the present invention engaged in a typical environment of a hand-held vacuum using an attachment.

FIG. 3 is a three-dimensional diagram of the hand-held vacuum thereof.

FIG. 4 is a three-dimensional diagram of the attachment of FIG. 2.

FIG. 5 is a three-dimensional diagram of a typical environment consisting of a leaf blower vacuum.

FIG. 6 is a three-dimensional diagram thereof showing the leaf blower vacuum affixed to the preferred embodiment of the present invention of FIG. 1.

FIG. 7 is a three-dimensional diagram of an alternative embodiment pet waste disposal attachment system.

FIG. 8 is a three-dimensional diagram thereof, shown affixed to a hand-held vacuum cleaner.

FIG. 9 is a three-dimensional diagram thereof, shown affixed to a hand-held leaf blower vacuum.

FIG. 10 is three-dimensional isometric view of an alternative embodiment of the present invention.

FIG. 11 is a partially exploded three-dimensional isometric view thereof.

FIG. 12 is an exploded three-dimensional isometric view thereof.

FIG. 13 is a three-dimensional isometric view showing the embodiment thereof interfacing with a bag element.

FIG. 14 is a three-dimensional isometric view of yet another alternative embodiment of the present invention.

FIG. 15 is a three-dimensional isometric view of another alternative embodiment thereof showing a perforated cup interfacing therewith.

FIG. 16 is a three-dimensional isometric view of yet another alternative embodiment thereof showing a perforated coffee filter interfacing therewith.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Waste Collection Attachment 2

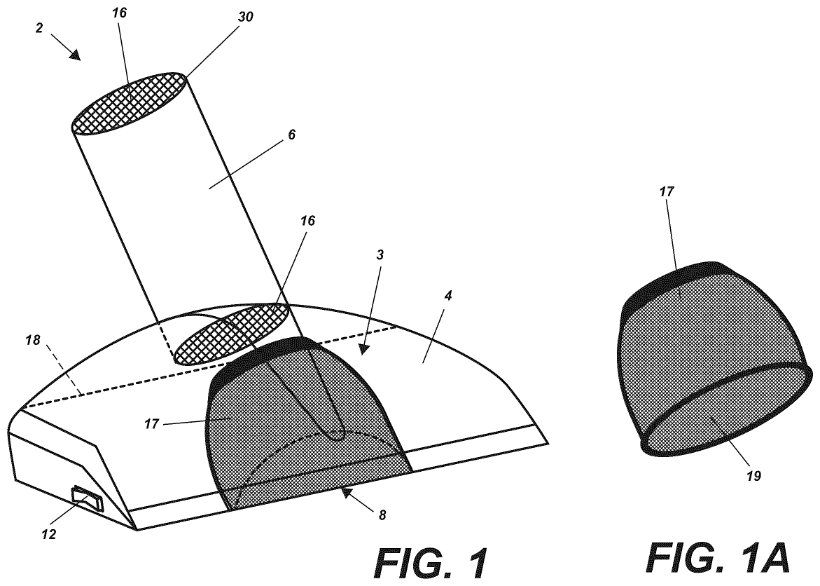

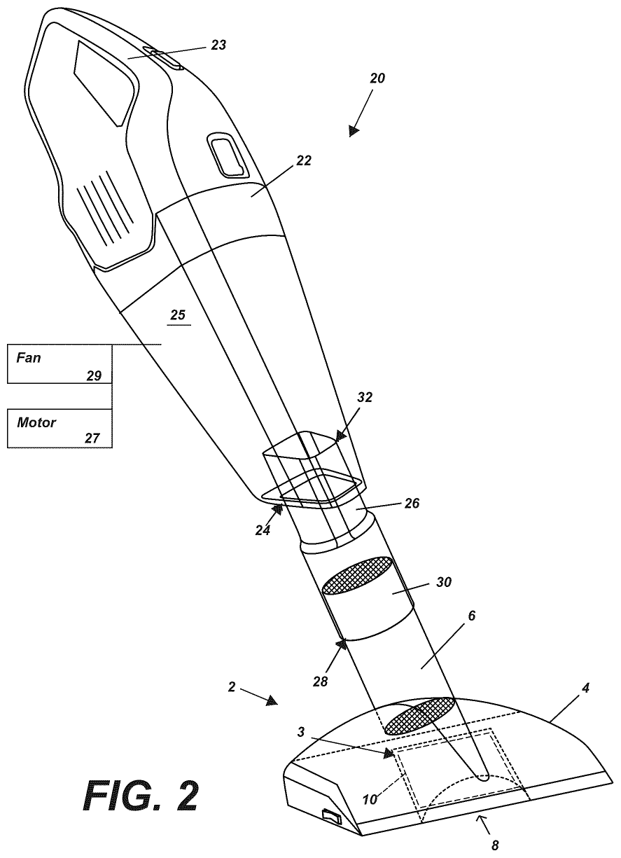

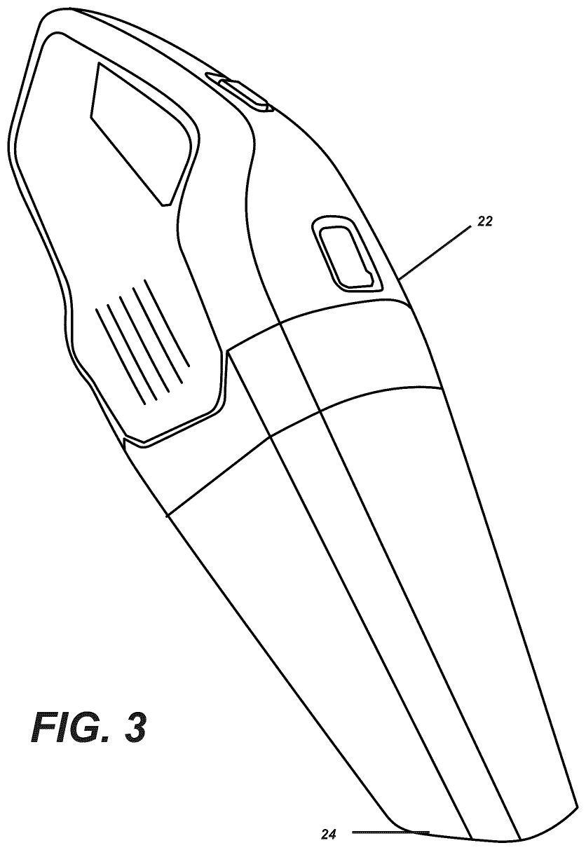

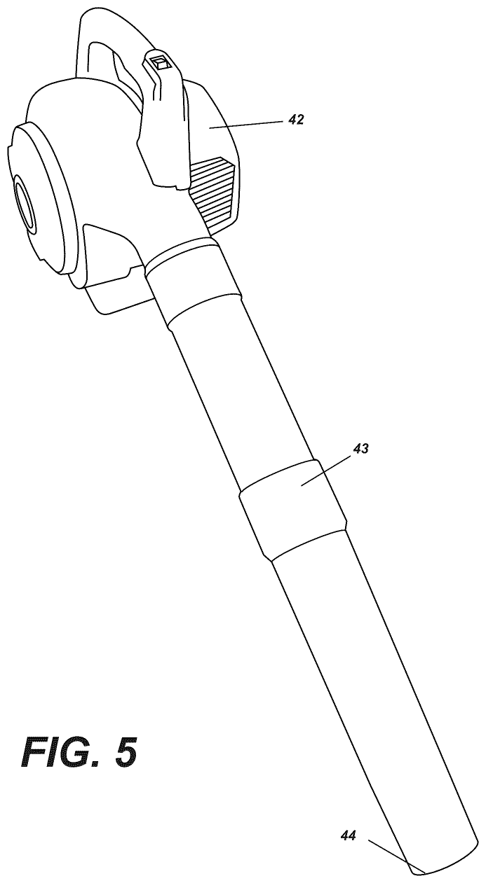

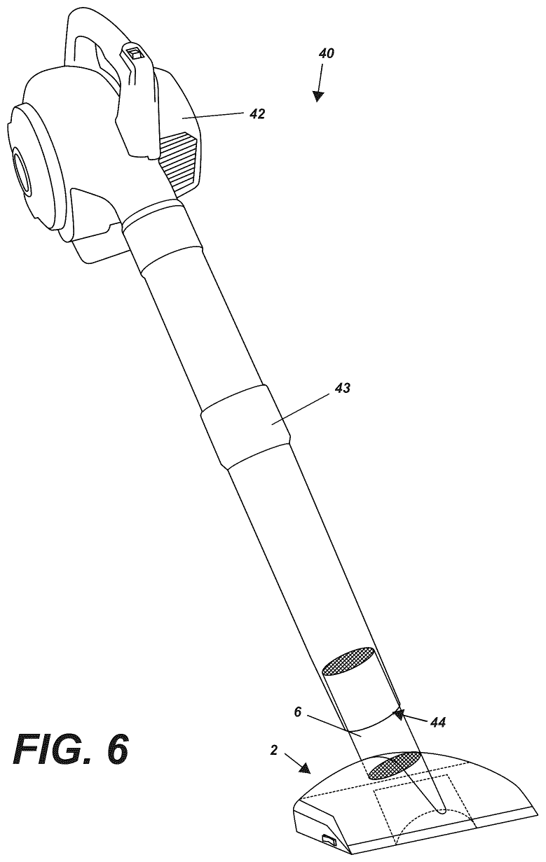

FIG. 1 shows a waste collection device 2 which has a base 4 housing an interior compartment 3, and a connector 6 for connecting the waste collection attachment 2 to a vacuum-capable device, such as a hand vacuum shown in FIGS. 2-3 or a leaf blower vacuum shown in FIGS. 5-6. Any suitable vacuum-capable device which has a motor 27, fan 29, housing 25, and handle 23 which, when attached to the waste collection device 2, makes it simple and easy to pick up waste such as pet waste. The base 4 could have lights, safety reflectors, or other features to aid the user in low-light areas.

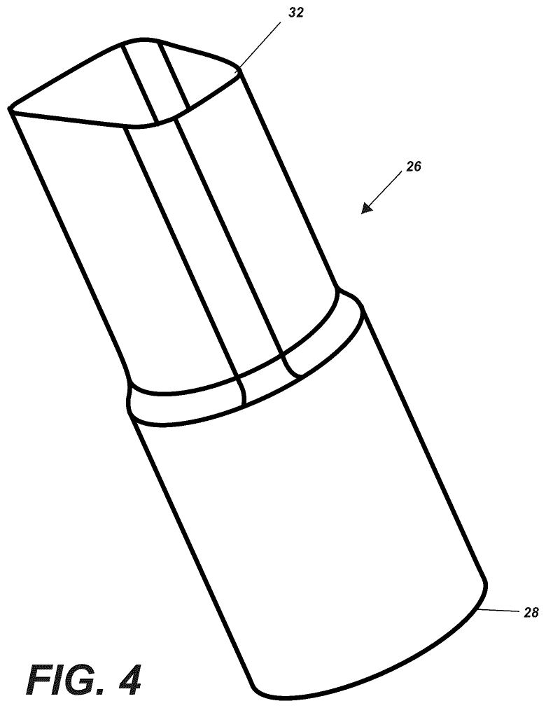

The waste collection device 2 has an opening 8 in the front of the base 4, a flap 10 for opening and cleaning the attachment, and an optional collection bag or filter 17 which further captures the waste and contains it for easy removal and cleaning. The bag or filter may also be disposable and thrown away. As shown in FIG. 1A, the filter/bag 17 has an opening 19 which receives the waste when it enters the base 4 through the opening 8. The entire base compartment front can be opened along a hinge 18 or other means of opening. A switch 12 can be used to lock or open the flap compartment. The connector 6 has a pair of mesh filter guard 16 for filters to prevent waste from being sucked into the vacuum device. The upper end 30 of the connector 6 connects to the vacuum device or an attachment which converts it for connecting to a vacuum device such as shown in FIG. 4.

As shown in FIG. 2, the waste collection device 2 can be connected to a hand vacuum 22 to form a waste collection vacuum 20. An attachment 26 connects the connector 6 to the end 24 of the vacuum 22. The upper end 32 of the attachment 26 is inserted into the end 24 of the vacuum as shown to secure it into place, and the lower end 28 of the attachment 26 connects to the upper end 30 of the connector 6. When the vacuum 22 is turned on, suction pulls waste into the opening 8 of the waste collection attachment 2 and is stored within the compartment base 4 or within an optional filter or bag 17. FIG. 3 shows the vacuum by itself. FIG. 4 shows the attachment 26 by itself. A number of attachments may be used to make the waste collection device 2 universally connectable to any vacuum device. Alternatively, the attachment 26 could have flexible or adjustable ends to fit vacuums and/or leaf blower vacuums universally.

FIG. 5 shows a standard leaf blower vacuum 42 which has a tube 43 with a tube end 44. The tubes do not have to be connected to the leaf blower vacuum 42 for attachment to the waste collection device 2, but may be used to extend reach. The leaf blower vacuum 42 must be capable of performing suction.

FIG. 6 shows the leaf blower vacuum 42 connected to the waste collection device 2 by connecting the connector 6 to the end 44 of the tube 43, thereby creating a waste collection vacuum 40.

### III. Alternative Embodiment Pet Waste Attachment System 102

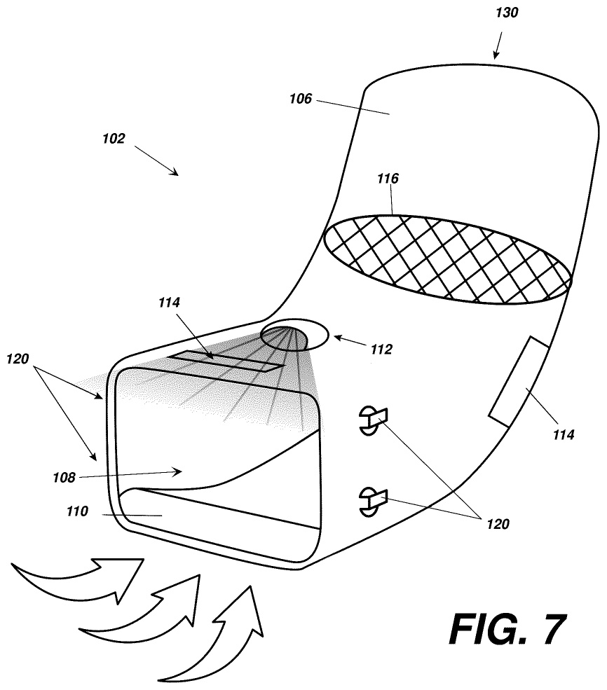

FIGS. 7-9 show an alternative embodiment pet waste attachment system 102 which has a connector 106 having an upper opening 130 designed to be fit to a device capable of providing suction, such as a vacuum cleaning device or leaf blower vacuum device. An attachment such as that shown in FIG. 4 may be used between the upper opening 130 and the device.

The front opening 108 of the pet waste attachment system 102 receives the pet waste as described in the embodiment above. A raised bar lip 110 at the forefront of the front opening 108 prevents a bag inserted into the opening from falling out. Side wing retention clips 120 located on either side of the front opening 108 further secure the bag in place within the opening. Reflectors 114 may be located around the exterior of the device, and a light source 112 may also be included. As with the embodiment above, a filter guard 116 may be placed within the connector 106.

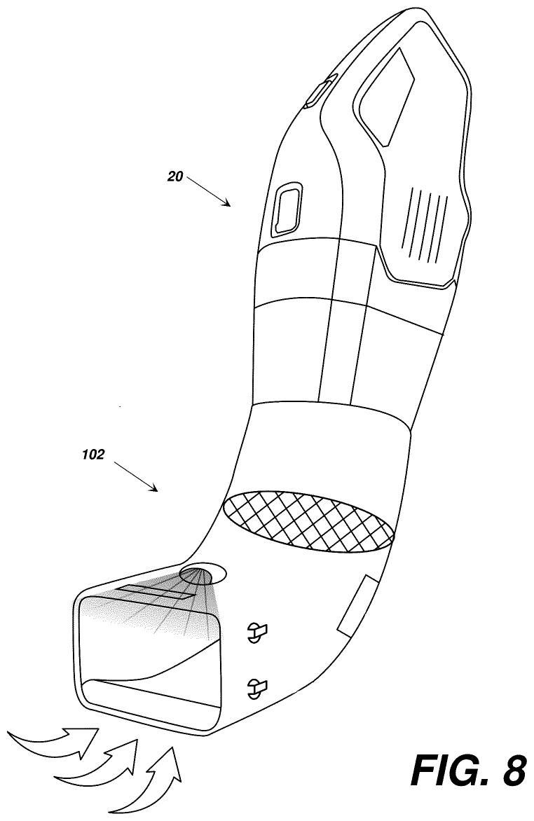

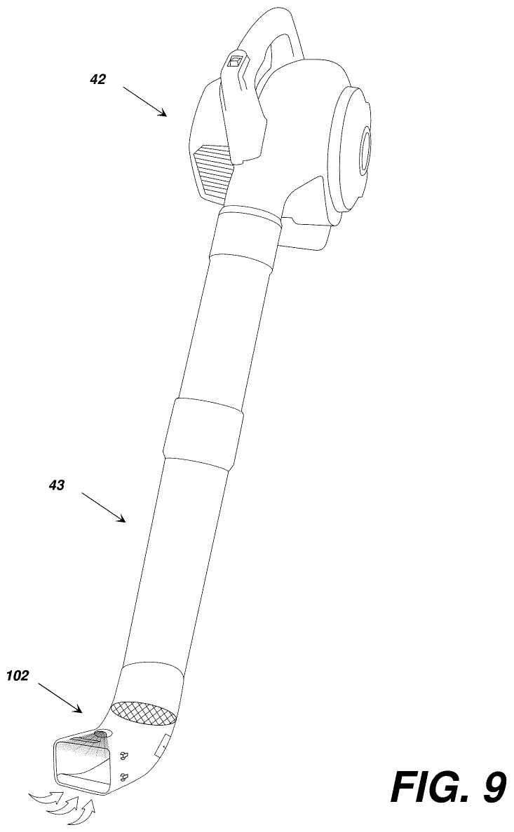

FIG. 8 shows the pet waste attachment system 102 connected to a hand-held vacuum cleaner 20. FIG. 9 similarly shows the pet waste attachment system 102 connected to a leaf blower vacuum 42 via an extension attachment 43.

### IV. Alternative Embodiment Pet Waste Attachment System 202

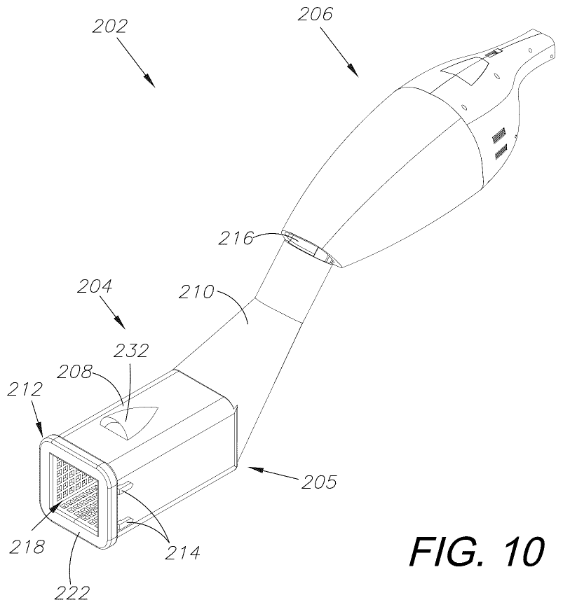

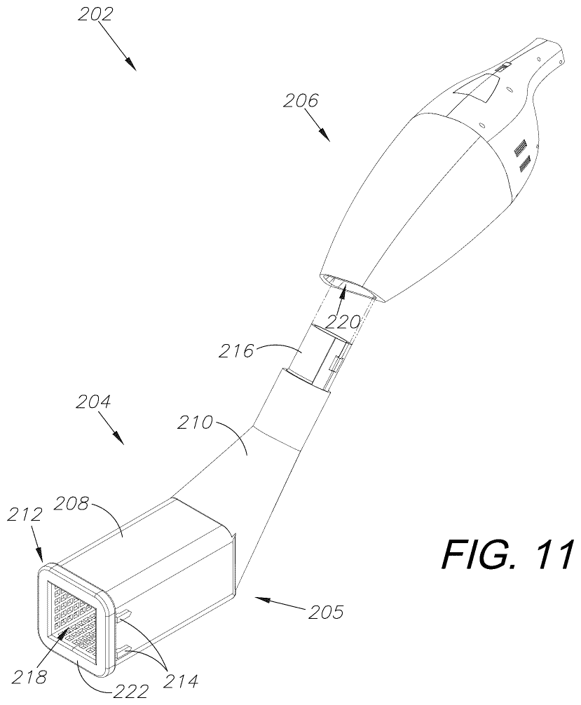

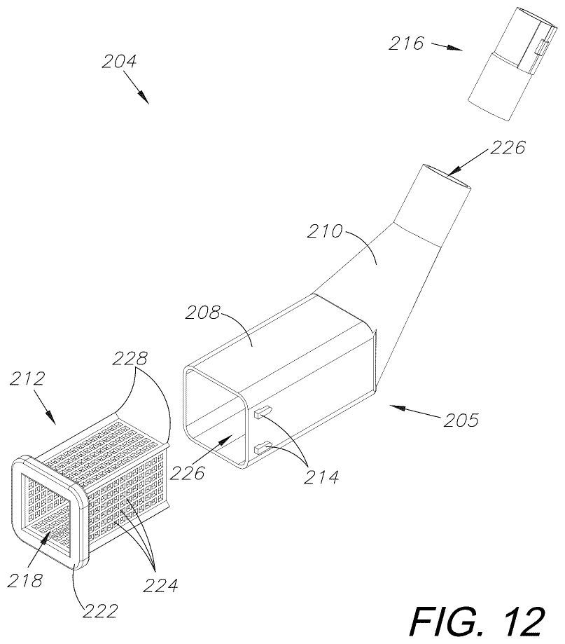

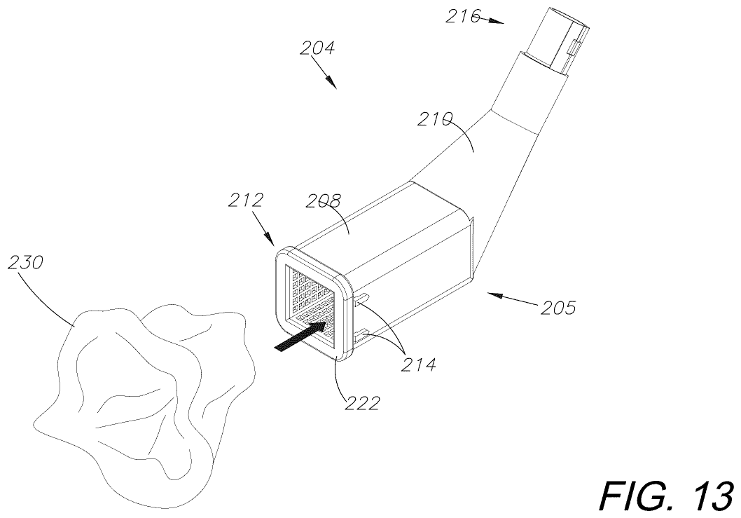

FIGS. 10-13 show an alternative embodiment pet waste attachment system 202. Here, an attachment 204 can interface with a hand-held vacuum 206 or other device that can provide suction. As shown, the attachment 204 includes a body 205 having a bottom portion 208 and a top portion 210. The top portion 210 includes an interface 216 which can be received within the open end 220 of the vacuum device 206. The interface 216 could be interchangeable to allow for the attachment device 204 to interface with all types of vacuum devices. Different connectors could be provided to interface with different vacuum devices.

The bottom portion 208 of the attachment 204 includes tabs 214 which can be used to connect to the edges of a bag 230. A filter guard 212 is inserted into the open end 226 of the bottom portion 208. The filter guard has a collection space 218 in the interior. The filter guard 212 can include a front lip 222 to secure the filter guard against the end of the bottom portion 208. The filter guard 212 can include a number of perforations 224 to allow air to pass through the filter guard to draw pet waste or other objects into the filter guard and any bag or other receptacle stored within the filter guard. The filter guard also includes raised corners 228 which further help to facilitate the air to be drawn into the filter guard to draw in waste or other items.

The bag 230 could be made of a breathable material to allow the air to draw through the bag and the filter guard 212.

The attachment 204 could include lights 232 in one or more locations to help with using the attachment to pick up objects in area of low or no light.

The filter guard 212 could be secured within the attachment 204 using magnets within both bodies. Magnets could similarly be used to secure the bag 230 into the filter guard.

### V. Alternative Embodiment Pet Waste System 302

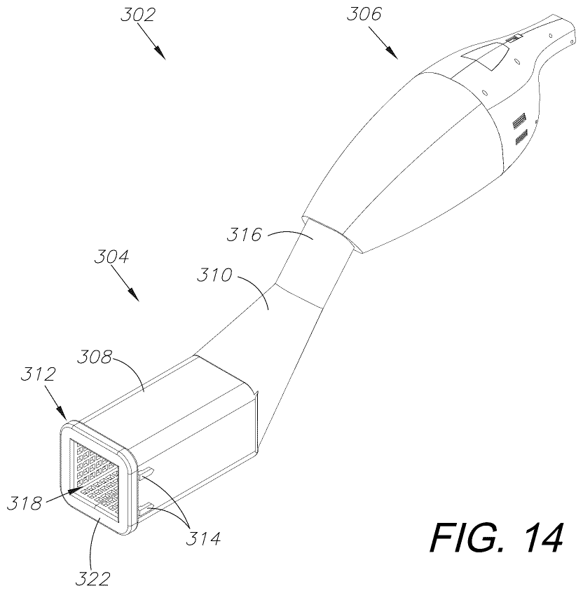

FIG. 14 shows an alternative embodiment pet waste collection system 302. Here, the collection element 304 and the vacuum element 306 are formed into a single device, rather than providing for a removable attachment as described in the previous embodiment. Here, the collection element 304 includes a bottom portion 308 and top portion 310 with a connector 316 to the handle and vacuum element 306. Otherwise, the filter guard 312 functions the same as before, with a securing lip 322, locking tabs 314 and interior collection space 318.

### VI. Alternative Embodiment Pet Waste System 402

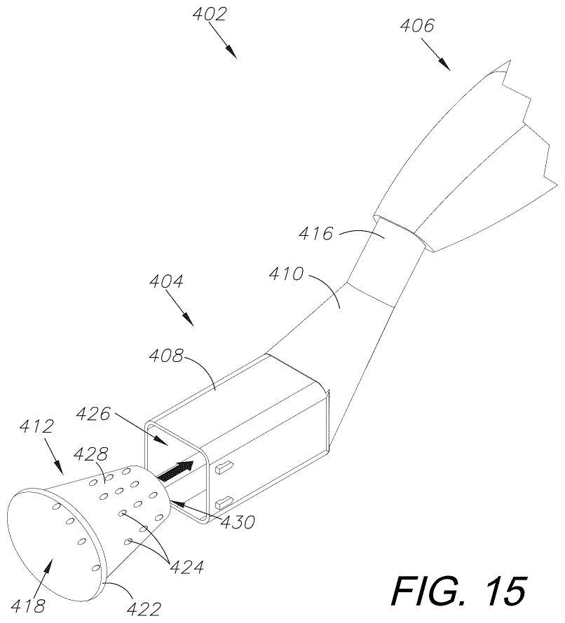

FIG. 15 shows another alternative embodiment pet waste collection system 402, which collection element 404 could be an attachment as with the previous pet waste system 202 or could be built into the vacuum device as with the previous pet waste system 302. Here, the collection element 404 includes a bottom portion 408 and top portion 410 with a connector 416 to the handle and vacuum element 406. Instead of a filter guard and a bag, a cup 412 with a number of perforations 424 within the cup body 428 for drawing air through the cup could be used. The pet waste or small items could be drawn into the cup 412 through the cup opening 418 by drawing air through the perforations 424 using the vacuum element 406. The bottom 430 of the cup would remain solid and unperforated, thereby functioning similar to the filter guard of the previous embodiment. Pet waste would fill and seal those perforations while the cup is filled. The cup can then be closed with a lid to secure the pet waste or other items to be disposed. The cup can have a lip 422 which secures the cup within the opening 426 of the bottom portion 408 of the collection element 404. The lip 422 can also receive a lid (not shown) for securing captured materials within the cup.

### VII. Alternative Embodiment Pet Waste System 452

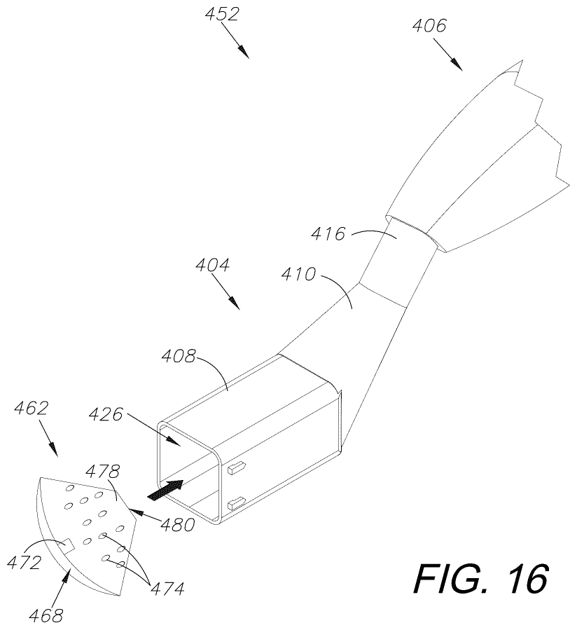

FIG. 16 shows yet another alternative embodiment pet waste collection system 452, identical to the previous embodiment 402, except a filter 462 is used instead of a cup. The filter includes a number of perforations 474 within the filter body 478 for drawing air through the filter could be used. The pet waste or small items could be drawn into the filter 478 through the filter opening 468 by drawing air through the perforations 474 using the vacuum element 406. The bottom 480 of the filter body 478 would remain solid and unperforated, thereby functioning similar to the filter guard of the previous embodiment. Pet waste would fill and seal those perforations while the filter is filled. Tabs 472 can be used to help to remove the filter. The filter could be formed from a typical coffee or tea filter or some other suitable material. The filter could include branding or logos, or could be embossed.

All of the embodiments of the present invention could be used to collect pet waste using the power of the respective vacuum device. Alternatively, small objects such as pills or toys could be drawn into the device and secured and stored.

The attachments of the various embodiments could be modified or include adapters for use with robotic devices, such as robotic lawn mowers or vacuum cleaners. Robotic vacuum devices include technology for avoiding objects such as pet waste. Such a feature could be reversed to target the picking up of pet waste or other desired small objects using an embodiment of the present invention.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A vacuum system comprising:
a waste collection device comprising an interior compartment comprising an opening, and a filter guard element configured to be inserted within said opening;
a vacuum element comprising a motor having a fan configured for sucking waste and debris into said opening; and
said filter guard configured to trap items drawn into said opening via said portable vacuum device.

2. The vacuum system of claim 1, further comprising:
said filter guard comprising at least one clip configured to receive a waste collection bag;
said waste collection bag configured to be removably inserted into said filter guard; and
wherein said waste collection bag is comprised of a material configured to allow air to be drawn through it such that said portable vacuum element is capable of sucking up said items.

3. The vacuum system of claim 2, wherein said items comprise pet waste.

4. The vacuum system of claim 2, wherein said items comprise small objects.

5. The vacuum system of claim 1, further comprising:
a cup configured to be removably inserted into said filter guard; and
wherein said cup comprises a plurality of perforations configured to allow air to be drawn through it such that said portable vacuum element is capable of sucking up said items.

6. The vacuum system of claim 1, further comprising:
a filter configured to be removably inserted into said filter guard; and
wherein said filter comprises a plurality of perforations configured to allow air to be drawn through it such that said portable vacuum element is capable of sucking up said items.

7. The vacuum system of claim 6, wherein said filter comprises a coffee filter.

8. The vacuum system of claim 6, wherein said filter comprises an embossed material.

9. The vacuum system of claim 6, wherein said filter comprises a plastic bag.

10. The vacuum system of claim 1, further comprising:
said waste collection device comprising a connector at an opposite end from said opening; and
said connector configured to interface with said portable vacuum element such that said connector is removably connected to an opening within said portable vacuum element.

11. The vacuum system of claim 10, wherein said items comprise pet waste.

12. The portable vacuum system of claim 10, wherein said items comprise small objects.

13. The vacuum system of claim 1, wherein said waste collection device comprises a light.

14. The vacuum system of claim 1, further comprising:
at least one magnet located within said waste collection device;
at least one magnet located within said filter guard, such that said at least one magnet of said filter guard is configured to magnetically interface with said at least one magnet of said waste collection device; and
whereby said at least one magnet located within said waste collection device secures said filter guard within said opening via said at least one magnet located within said filter guard.

15. The vacuum system of claim 1, further comprising:
said filter guard comprising a cup configured to be removably inserted into said filter guard; and
wherein said cup comprises a plurality of perforations configured to allow air to be drawn through it such that said portable vacuum element is capable of sucking up said items.

16. The vacuum system of claim 1, further comprising:
said filter guard comprising a filter configured to be removably inserted into said filter guard; and
wherein said filter comprises a plurality of perforations configured to allow air to be drawn through it such that said portable vacuum element is capable of sucking up said items.

17. The vacuum system of claim 1, further comprising:
said vacuum device comprising a portable vacuum device; and
said portable vacuum device comprising a handle.

18. The vacuum system of claim 1, further comprising:
said vacuum device comprising a self-guided robotic vacuum device; and
said self-guided robotic vacuum device comprising software configured for targeting said items.
